(19) United States
(12) Patent Application Publication
(10) Pub. No.: US 2005/0129244 A1
(43) Pub. Date: Jun. 16, 2005

(54) System and method for mitigating denial of service attacks on trusted platform

(75) Inventors: Ryan Charles Catherman, Raleigh, NC (US); David Carroll Challener, Raleigh, NC (US); James Patrick Hoff, Raleigh, NC (US); Hernando Ovies, Cary, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 10/736,973

(22) Filed: Dec. 16, 2003

(51) Int. Cl. H04L 9/00

(52) U.S. Cl. 380/277

(57) ABSTRACT

Trusted platform module (TPM) keys are copied to a floppy diskette or fob that is external to the customer device in which the TPM resides, so that if the keys in TPM are zeroed as a result of, e.g., a malicious denial of service attack, they can be copied back from the diskette or fob.

### FIELD OF THE INVENTION

The present invention relates generally to secure computing devices.

### BACKGROUND OF THE INVENTION

Trust has become an important issue for e-commerce and other applications, particularly for mobile computing devices such as notebook computers. Specifically, as the mobility of the computing platform increases, it becomes susceptible to theft, with stolen data often representing a bigger loss than the hardware itself, because the data can include, e.g., user identity information, credit card information, and so on.

With this in mind, the Trusted Computing Platform Alliance (TCPA) has been formed to develop a specification for a trusted computing platform. Using a hardware security module (actually, a microcontroller) known as the Trusted Platform Module (TPM) that is soldered to the motherboard of the computing platform, the TCPA establishes what can be thought of as a platform root of trust that uniquely identifies a particular platform and that provides various cryptographic capabilities including hardware-protected storage, digital certificates, IKE (Internet Key Exchange), PKI (Public Key Infrastructure), and so on. Essentially, to overcome the vulnerability of storing encryption keys, authentication certificates, and the like on a hard disk drive, which might be removed or otherwise accessed or tampered with by unauthorized people, encryption keys, certificates, and other sensitive data is stored on the secure TPM.

The various keys including the endorsement keys are unique to the TPM. The keys can be used to in turn encrypt other keys for various purposes, thereby extending the trust boundary as desired. The validity of the endorsement keys is attested to by an electronic document known as an endorsement certificate that is provided by someone other than the entity that provides the keys and that is generated using the TPM public half of the endorsement key.

It is sometimes desirable that the keys of a TPM be cleared by erasing the keys (by, e.g., setting to zero all bit values of the keys) when it is detected that the device has been tampered with. This clearing of keys disables all or a portion of the device, to prevent an unauthorized tamperer from accessing information on the device. As recognized by the present invention, while this feature has its advantages it also has the disadvantage of creating an opportunity for a malicious hacker to deny service to the owner of the device by causing the keys to be unnecessarily zeroed. Such an attack is sometimes referred to as a “denial of service” attack, wherein the hacker does not gain any particular access or advantage but simply denies the service of the device to its rightful owner. Accordingly, the present invention recognizes the desirability of mitigating the effects of a denial of service attack.

### SUMMARY OF THE INVENTION

A method is disclosed for copying at least one endorsement key associated with a security module of a customer computing device to an external storage device, and, if the endorsement key in the security module is zeroed or otherwise disabled, communicating with the external storage device using the customer computing device. The method includes transmitting the endorsement key from the storage device to the security module.

Preferably, the security module is a trusted platform module (TPM), and the external storage device may be a floppy diskette or a fob that is external to the customer device and is external to a cryptographic boundary established by the security module. If desired, the endorsement key can be encrypted prior to copying using a volatile transfer key. In one non-limiting embodiment, the method can include disabling the customer computing device for a predetermined time period after the endorsement key in the customer computing device has been cleared to zero or otherwise disabled. The method can also include disabling the customer computing device for a predetermined time period after transferring the endorsement key to the customer computing device from the external storage device.

In another aspect, a customer computing device includes a security module that in turn includes at least one cryptographic key;, and a processor operatively connected to the security module. An external storage device is operatively connected to the processor for holding a copy of the cryptographic key. The processor executes logic that includes, upon loss or disablement of the key from the security module, receiving, from the external storage device, the copy of the cryptographic key for use thereof by the security module.

In still another aspect, a service includes maintaining a copy of at least one cryptographic key associated with a security module of a customer computing device on an external storage device. The service also includes, upon determining that the cryptographic key is zeroed or otherwise disabled, transmitting the cryptographic key from the external storage device to the security module.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture; and

FIG. 2 is a flow chart of the presently preferred logic.

### DETAILED DESCRIPTION OF THE PREFERRED EMBODIMENT

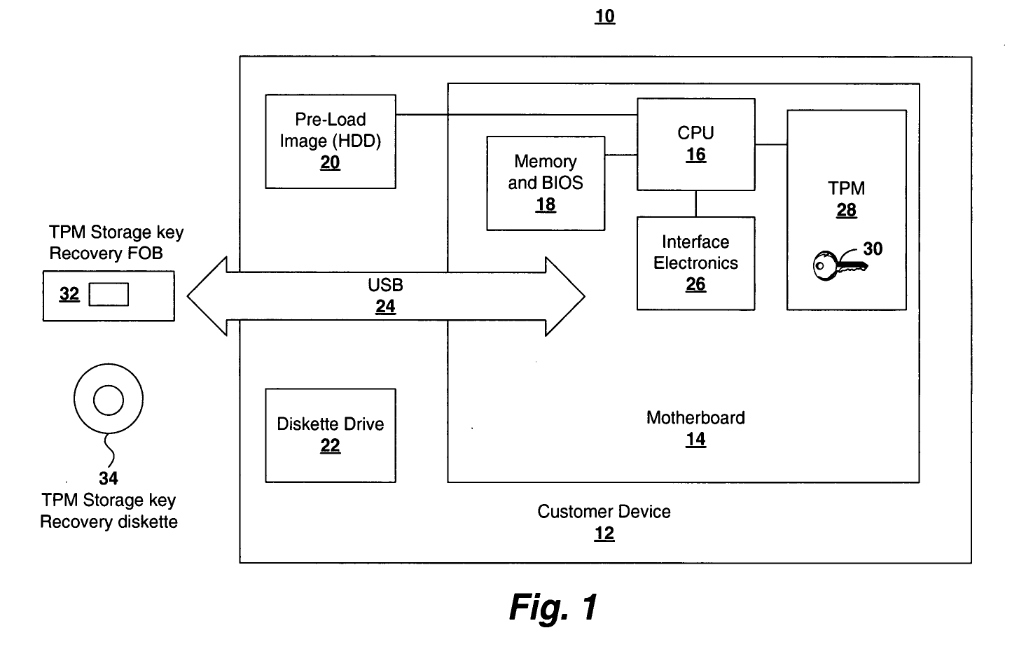

Referring initially to FIG. 1, a computing system is shown, generally designated 10, that includes a customer computing device or platform 12. The customer device 12 can be any suitable computer, e.g., a personal computer or larger, a laptop computer, a notebook computer or smaller, etc.

As shown in FIG. 1, the preferred non-limiting customer device 12 includes a motherboard 14 on which is mounted at least one main central processing unit (CPU) 16 that can communicate with a solid state memory 18 on the motherboard 14. The memory 18 can contain basic input/output system (BIOS) instructions useful for booting the device 12 at start up. Additionally, other storage can be provided external to the motherboard 14, e.g., a hard disk drive 20 (that can hold a pre-load image of the software state of the device 12 upon completion of start up) and a floppy diskette drive 22. Moreover, the CPU 16 can communicate with external devices through a universal serial bus (USB) 24 using interface electronics 26 in accordance with USB principles known in the art.

As intended by the present invention, the customer device 12 can be rendered into a trusted device by the user. To this end, a security module such as a trusted platform module (TPM) 28 is provided on the motherboard 14. The presently preferred non-limiting TPM 28 is a hardware module that is soldered or otherwise affixed to the motherboard 14. Among other things, the TPM 28 contains various encryption keys 30, including storage keys, endorsement keys, and so on. The endorsement keys are either generated at manufacturing time outside the TPM and then sent (“squirted”) to the TPM for storage, or the keys are generated within the TPM itself.

In accordance with the present invention, one or more of the keys 30 in the TPM 28 can be copied (preferably in encrypted form) to a portable storage device that is external to the customer device 12 and that is also external to the cryptographic boundary established by the TPM 28. For example, the keys may be stored on a recovery fob 32 that can be engaged with the USB 24 in accordance with USB principles known in the art to communicate data to and from the CPU 16. Or, the keys may be stored on a floppy diskette 34 that can be engaged with the floppy drive 22 in accordance with floppy drive principles known in the art to communicate data to and from the CPU 16. Other portable storage devices are contemplated herein.

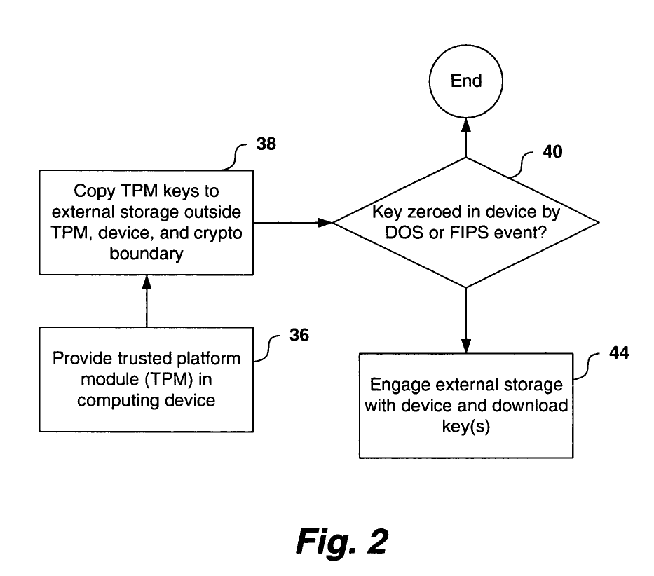

FIG. 2 shows the present logic, which can be provided as a service if desired. Commencing at block 36, the TPM 28 is provided in the customer device 12. The TPM 28 may be enabled by the user sometime after purchase, if desired, during an “ownership” phase.

Once the TPM 28 is enabled (or even before, if desired), one or more keys 30 are copied to the external storage device (e.g., floppy diskette 34 or fob 32) at block 38. This copying can be executed under the control of the CPU 16. As mentioned above and as indicated in FIG. 2, this external storage is external to the customer device 12 and to the cryptographic boundary of the TPM 28.

In the preferred embodiment, the keys from the TPM 28, and in particular the endorsement keys, are first encrypted by the TPM before being sent beyond the TPM. This can be done by encrypting the keys with a separate volatile transfer key that is never sent outside the TPM 28 and that has a limited user-defined lifetime, after which it is erased or otherwise rendered unusable by the TPM and, hence, after which the encrypted copies of the keys on fob or diskette can no longer be decrypted by the TPM for use. The limited lifetime of the transfer key may commence from the time the endorsement keys are encrypted and transmitted for storage.

Decision diamond 40 simply indicates that when no key is zeroed or otherwise disabled the logic ends at state 42, but when a key or keys 30 is zeroed or otherwise disabled by a tamper event, such as an event defined in the Federal Information Processing Standards (FIPS) 140 or, as recognized herein, an event deliberately caused by a malicious denial of service attack, the external storage device may be engaged with the customer device 12 at block 44 to download copies of the keys to the TPM 28 under the control of the CPU 16. The keys may be decrypted in the TPM using the transfer key mentioned above, provided the transfer key has not exceeded its lifetime. The ownership routine of the TPM 28 may then be re-executed. The CPU 16 and/or TPM 28 may execute the decision at decision diamond 40.

It is preferred that at least a portion of the customer device 12 remains disabled for a predetermined time period after copies of the keys in the customer device 12 have been cleared to zero or otherwise disabled to prevent an attacker from immediately taking ownership of the device 12. For example, a time delay can be implemented between key zeroing and acceptance of new keys from the external storage device, during which delay no ownership or other predetermined action can be undertaken by the CPU 16 and/or TPM 28. Or, a time delay in like functions can be implemented after keys have been copied from the external storage.

As mentioned above, a service can be provided that executes at least a portion of the above logic, including maintaining a copy of a cryptographic key on an external storage device and providing the key to the user as needed. The user can then be billed for the service on, e.g., a per-event basis or on a subscription basis.

While the particular SYSTEM AND METHOD FOR MITIGATING DENIAL OF SERVICE ATTACKS ON TRUSTED PLATFORM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history. The method claimed herein may be implemented by hardware, software, or a combination thereof.

1. A method, comprising the acts of:
copying at least one endorsement key associated with a security module of a customer computing device to an external storage device;
if the at least one endorsement key in the security module is zeroed or otherwise disabled, communicating with the external storage device using the customer computing device; and
transmitting the at least one endorsement key from the storage device to the security module.

2. The method of claim 1, wherein the security module is a trusted platform module (TPM).

3. The method of claim 1, wherein the external storage device is at least one of: a floppy diskette, and a fob.

4. The method of claim 1, wherein the at least one endorsement key is encrypted prior to the copying act.

5. The method of claim 4 wherein the encryption of the at least one endorsement key is performed using a volatile transfer key.

6. The method of claim 1, comprising disabling at least a portion of the customer computing device for a predetermined time period after the at least one endorsement key in the customer computing device has been cleared to zero or otherwise disabled.

7. The method of claim 1, wherein the external storage device is external to the customer device and is external to a cryptographic boundary established by the security module.

8. The method of claim 1, comprising disabling at least a portion of the customer computing device for a predetermined time period after transferring the at least one endorsement key to the customer computing device from the external storage device.

9. A customer computing device, comprising:
at least one security module including at least one cryptographic key;
at least one processor operatively connected to the security module; and
an external storage device operatively connected to the at least one processor and holding a copy of the at least one cryptographic key, wherein the at least one processor executes logic comprising:
upon loss or disablement of the key from the security module, receiving, from the external storage device, the copy of the at least one cryptographic key for use thereof by the security module.

10. The device of claim 9, wherein the security module is a trusted platform module (TPM).

11. The device of claim 9, wherein the external storage device is at least one of: floppy diskette, and a fob.

12. The device of claim 9, wherein the external storage device is external to the customer computing device and external to a cryptographic boundary established by the security module.

13. The device of claim 9, wherein the copy of the at least one cryptographic key held by the external storage device is encrypted.

14. The device of claim 13, wherein a volatile transfer key is used for encrypting and decrypting the copy of the at least one cryptographic key.

15. The device of claim 9, wherein at least one of: the processor, and security module, includes logic for disabling at least a portion of the customer device for a predetermined time period after the at least one cryptographic key in the customer device has been cleared to zero or otherwise disabled.

16. The device of claim 9, wherein at least one of: the processor, and security module, includes logic for disabling at least a portion of the customer device for a predetermined time period after the copy of the at least one cryptographic key has been received from the external storage device.

17. A service comprising:
maintaining a copy of at least one cryptographic key associated with a security module of a customer computing device on an external storage device; and
upon determining that the at least one cryptographic key in the security module is zeroed or otherwise disabled, transmitting the at least one cryptographic key from the external storage device to the security module.

18. The service of claim 17, wherein the security module is a trusted platform module (TPM).

19. The service of claim 17, wherein the external storage device is at least one of: a floppy diskette, and a fob.

20. The service of claim 17, wherein the copy of the at least one cryptographic key is encrypted using a volatile transfer key prior to being stored by the external storage device.

21. The service of claim 17, comprising disabling at least a portion of the customer computing device for a predetermined time period after the at least one cryptographic key in the customer computing device is cleared to zero or otherwise disabled.

22. The service of claim 17, comprising disabling at least a portion of the customer computing device for a predetermined time period after transmitting the at least one cryptographic key to the customer computing device from the external storage device.

23. The service of claim 17, wherein the external storage device is external to the customer computing device and is external to a cryptographic boundary established by the security module.
